(19) United States
(12) Patent Application Publication
(10) Pub. No.: US 2024/0383132 A1
(43) Pub. Date: Nov. 21, 2024

(54) GEOMETRIC ALGEBRA TRANSFORMERS

(71) Applicant: QUALCOMM Incorporated, San Diego, CA (US)

(72) Inventors: Johann Hinrich BREHMER, Amsterdam (NL); Soenke BEHRENDS, Amsterdam (NL); Pim DE HAAN, Amsterdam (NL); Taco Sebastiaan COHEN, Amsterdam (NL)

(21) Appl. No.: 18/515,146

(22) Filed: Nov. 20, 2023

Related U.S. Application Data
(60) Provisional application No. 63/502,613, filed on May 16, 2023.

(51) Int. Cl. B25J 9/16

(52) U.S. Cl. CPC B25J 9/163; B25J 9/1664

(57) ABSTRACT

Systems and techniques are described herein for operating an apparatus having a geometric algebra transformer. A computing device can receive, at a geometric algebra transformer, multivector inputs processed from raw data associated with a three-dimensional space. The computing device can process, via the geometric algebra transformer, the multivector inputs to generate multivector outputs. The geometric algebra transformer is trained to process geometric algebra representations associated with the multivector inputs and to be equivariant with respect to translations and rotations.

### PRIORITY CLAIM

The present application claims the benefit of U.S. Provisional Application No. 63/502,613, filed on May 16, 2023, which is hereby incorporated by reference, in its entirety and for all purposes.

### TECHNICAL FIELD

The present disclosure generally relates to processing data using machine learning systems. For example, aspects of the present disclosure include systems and techniques for providing a geometric algebra transformer which can be tailored for a three-dimensional space and equivariant with respect to symmetries of three-dimensional space.

### BACKGROUND

Various technical fields (e.g., molecular dynamics, astrophysics, material design, and robotics) deal with geometric data, including points, directions, surfaces, orientations, and so forth. Neural network models (e.g., reinforcement learning algorithms) are often modeled to control objects or material (e.g., robots, molecules, materials, etc.) in such environments and may sample states, take actions, and observe rewards or results for the actions. For every state and a possible action, the neural network model may predict an expected reward and an expected future state. Modeling the expected reward is a regression problem and modeling the expected future state is a density estimation problem. Current neural network models treat data as an unstructured vector of numbers, which results in the networks requiring a large amount of training data and which reduces the ability of the networks to generalize to new situations.

### SUMMARY

Systems and techniques are described for providing a geometric algebra transformer. The geometric algebra transformer can be used as a general model that can be used to solve any problem with inputs and outputs that are geometric in nature. The geometric algebra transformer is agnostic as to the problem to be solved. The geometric algebra transformer may be trained to perform a single task or to perform more than one task. The geometric algebra transformer may act either on specific instructions regarding the task to be achieved or operate on another type of input according to its training.

A processor-implemented method of processing data through a geometric algebra transformer can include receiving, at a geometric algebra transformer, multivector inputs processed from raw data associated with a three-dimensional space; and processing, via the geometric algebra transformer, the multivector inputs to generate multivector outputs, wherein the geometric algebra transformer is trained to process geometric algebra representations associated with the multivector inputs and to be equivariant with respect to translations and rotations. The geometric algebra transformer further can include an input equilinear layer; a transformer block; and an output equilinear layer.

An apparatus for providing a geometric algebra transformer, the apparatus having: at least one memory; and at least one processor coupled to at least one memory and configured to operate as a geometric algebra transformer to: receive multivector inputs processed from raw data associated with a three-dimensional space; and process the multivector inputs to generate multivector outputs, wherein the geometric algebra transformer is trained to process geometric algebra representations associated with the multivector inputs and to be equivariant with respect to translations and rotations.

In another aspect, a processor-implemented method of operating a geometric algebra transformer can include receiving, at a geometric algebra transformer, multivector inputs processed from raw data associated with a three-dimensional space; and processing, via the geometric algebra transformer, the multivector inputs via at least a one normalization layer, a geometric attention layer that applies a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.

In another aspect, an apparatus for providing a geometric algebra transformer is disclosed. The apparatus includes at least one memory; and at least one processor coupled to at least one memory and configured to operate as a geometric algebra transformer to: receive multivector inputs processed from raw data associated with a three-dimensional space; and process the multivector inputs via at least a one normalization layer, a geometric attention layer that applies a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.

In another aspect, a non-transitory computer-readable medium is disclosed. The transitory computer-readable medium has stored thereon instructions that, when executed by one or more processors, cause the one or more processors to perform operations according any of the methods or processes disclosed herein.

In another aspect, an apparatus for processing data via a geometric algebra transformer is disclosed. The apparatus includes one or more means for performing any of the operations disclosed herein.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates a table of embeddings of common objects and transformations, according to aspects of the disclosure;

FIG. 2 is a diagram illustrating an example use of a geometric algebra transformer, according to aspects of the disclosure;

FIG. 3 is a diagram illustrating an example of the geometric algebra transformer, according to aspects of the disclosure;

FIG. 4 illustrates results of n-body dynamics experiments, according to aspects of the disclosure;

FIG. 5 illustrates results of wall-shear-stress estimation on human arteries, according to aspects of the disclosure

FIG. 6 illustrates results of diffusion-based robotic planning, according to aspects of the disclosure

FIG. 7 illustrates the results of computation cost and scaling experiments, according to aspects of the disclosure

FIG. 8A is a flow diagram illustrating an example method associated with using a geometric algebra transformer, according to aspects of the disclosure;

FIG. 8B is a flow diagram illustrating an example method associated with using a geometric algebra transformer, according to aspects of the disclosure; and

FIG. 9 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Geometric data is highly structured. For example, geometric data can be categorized into certain types, such as a three-dimensional coordinate of an object, a velocity vector, a weight of the object, etc. These geometric types of objects can inform a system of typical operations that can be performed with respect to the objects. However, traditional machine learning models are not configured to process such geometric data structures, which can lead to inefficiencies. For example, traditional machine learning models (e.g., neural network models) treat data as an unstructured vector of numbers, rather than geometric objects, require large amount of training data, and generalize poorly to new situations.

Another aspect of the highly structured nature of geometric data is that, when coordinate systems are changed (e.g., by moving the origin of a coordinate system to a new location), the numbers with which the data is represented can change, but the actual behavior of the system does not change. The fact that the behavior does not change is also reflected in how geometric data is structured. In robotics and other situations where a machine learning model (e.g., a neural network) learns behaviors or patterns from training data, it can be very beneficial to take the structure of geometric data into account.

Machine learning systems should be generalizable to situations outside of examples provided in training data. For example, a neural network can typically be trained for one type of situation (e.g., for classification, image segmentation, etc.). However, the neural network should also perform well when a new situation arises. Machine learning systems should also be efficient with respect to data samples. For instance, when a neural network is trained on limited data (e.g., 100, 500, 1000, or other number of training samples for the neural network model), the network should still perform well. Machine learning algorithms, including reinforcement learning algorithms, generally do not take into account the structure of geometric data, in which case they are often not able to generalize to new situations and are not sample efficient.

Systems, apparatuses, processes (also referred to as methods), and computer-readable media (collectively referred to as “systems and techniques”) are described herein that provide a geometric algebra transformer (GATr) as part of a new neural network architecture that can be used in many different contexts, such as robotic control, molecular dynamics, climate science, autonomous driving, planetary trajectory predictions, among others.

Various fields of science and engineering are related to geometric data (e.g., points, directions, surfaces, orientations, etc.), including molecular dynamics, astrophysics, material design, robotics, robotic control, molecular dynamics, climate science, autonomous driving, planetary trajectory predictions, among others. The geometric nature of data provides a rich structure. The systems and techniques described herein take into account the notion of common operations between geometric types (e.g., computing distances between points, applying rotations to orientations, etc.), and of a well-defined behavior of data under transformations of a system. The systems and techniques also consider the independence of certain properties of coordinate system choices. For example, when learning from geometric data (e.g., learning relations between geometric objects from data), the systems and techniques incorporate the rich structure related to various geometric types into the architecture. Incorporating the rich structure into the architecture can improve the performance of the neural network architecture (e.g., by improving sample efficiency and generalization of the model).

The GATr described herein provides a general-purpose network architecture for geometric data. The GATr utilizes geometric algebra, equivariance, and transformers to perform one or more tasks. For example, to naturally describe both geometric objects as well as their transformations in three-dimensional space, the GATr can represent data as multivectors of the projective geometric algebra [symbol] _{3,0,1}. Geometric (or Clifford) algebra is a principled yet practical mathematical framework for geometrical computations. The particular algebra [symbol] _{3,0,1} extends the vector space [symbol] ³ to 16-dimensional multivectors, which can natively represent various geometric types and E(3) poses. Unlike the O(3) representations popular in geometric deep learning, this algebra faithfully represents absolute positions and translations.

As noted above, the GATr can utilize equivariance. For example, the GATr is equivariant with respect to E(3), the symmetry group of three-dimensional space. To this end, disclosed are several new E(3)-equivariant primitives mapping between multivectors, including equivariant linear maps, an attention mechanism, nonlinearities, and normalization layers.

As further noted above, the GATr can also make use of transformers. For instance, due to its favorable scaling properties, expressiveness, trainability, and versatility, the transformer architecture has become the de-facto standard for a wide range of problems. The GATr is based on the transformer architecture, in particular on dot-product attention, and hence inherits these benefits.

In general, a transformer is a deep learning model. A transformer can perform self-attention (e.g., using at least one self-attention layer), differentially weighting the significance of each part of the input (which includes the recursive output) data. Transformers can be used in many contexts, including the fields of natural language processing (NLP) and computer vision (CV). Like recurrent neural networks (RNNs), transformers are designed to process sequential input data, such as natural language, with application to tasks such as translation and text summarization. However, unlike RNNs, transformers process the entire input all at once. The attention mechanism provides context for any position in the input sequence. For example, if the input data is a natural language sentence, the transformer does not have to process one word at a time. The approach allows for more parallelization than RNNs and therefore reduces training times. Compared to RNN models, transformers are more amenable to parallelization, allowing training on larger datasets.

The GATr described herein can be based on processed data from a three-dimensional space or context that is prepared with geometric algebra representations. For example, the GATr can be designed for the geometric structure of the three-dimensional space (e.g., a robotic environment) by processing the data and can be useful for high level control of such contexts (e.g., robotics and/or other applications). The GATr can also be equivariant with respect to symmetries of the three-dimensional space. For instance, the GATr can be configured with multiple novel network layers that maintain E(3) equivariance. The term E(3) relates to the group of rotations, reflections and translations in three-dimensional space.

In some aspects, the GATr can receive a multivector input, process the input using various layers or engines such as equilinear layers, normalization layers, a geometric attention layer, and geometric product engines to generate a multivector output. Data can be extracted from the multivector output and used to perform a task, such as controlling a movement of a robotic arm or other task. Other example applications include molecular modeling and planetary trajectory modeling. A multivector represents both geometrical objects (linear subspaces) and operators (rotations and reflections). There may be a plurality of values in a multivector (e.g., embedded into the multivector), where each value can represent a respective object (e.g., a geometric object, such as a scalar, a vector, a bivector, a trivector, a pseudoscalar, etc.) of a respective operator.

Various applications of the GATr include robotics, molecular dynamics, astrophysics, among others. These various fields deal with geometric data, including points, directions, surfaces, orientations, etc. The geometric nature of data provides a rich structure that benefits from the common operations between geometric types, a well-defined behavior of data under transformations of a system, and the independence of certain properties of coordinate system choices.

One illustrative example use of the GATr disclosed herein is for controlling a robotic arm. For example, a simple task for which to solve is to control the robotic arm to move objects from one location to another location along a particular path. To control the robot, a standard network architecture can be implemented. However, the robotic arm does not process numerical inputs, but instead interacts with physical objects in a three-dimensional world. For example, to interact with a block on a table that has a position in three-dimensional coordinates, a task of the robotic arm can be to move the block from one place to another using a direction vector in three-dimensional coordinates.

The disclosed GATr can be trained to perform a task so that the transformer is E(3) equivariant and is agnostic as to the kind of training algorithm used or the kind of specific task or service for which the transformer is implemented. The GATr also includes internal representations that are particular for geometric three-dimensional data. As noted previously, the GATr is E(3) equivariant (e.g., equivariant with respect to the symmetries of three-dimensional space). Using the prior illustrative example of the robotic arm, one could change the coordinate system of the three-dimensional space and the behavior of the robotic arm would stays the same. In one example, if the GATr is trained to control a robotic arm to move a block from the left side of the table to the right side of the table, based on the GATr being trained so that it is E(3) equivariant, the robotic arm can also move the block from the right side of the table to the left side of the table (even though it was not trained to do so) because the physics of such a movement does not change from the training data.

As another example, the GATr can receive the coordinates of an object and a velocity (e.g., a direction vector with a length) with which to move the object. The velocity can be applied to the coordinates and the object can be moved along the velocity vector. This is different from the kind of operations one would typically expect if a machine learning system receives as input numbers that describe a temperature or a weight of the object.

The GATr concept combines two lines of research: the representation of geometric objects with geometric algebra, popular in computer graphics and physics and can be applied to deep learning. and the encoding of symmetries through equivariant deep learning. The result is the first E(3)-equivariant architecture with internal geometric algebra representations. The architecture is a versatile network for problems involving geometric data.

The GATr can be demonstrated in three problems from entirely different fields. In an n-body modelling task, one can compare GATr to various baselines. The task of predicting the wall shear stress in human arteries can be used to demonstrate that GATr scales to realistic problems with meshes of thousands of nodes. One can apply GATr to robotic motion planning, using the architecture as the backbone of an E(3)-invariant diffusion model. In all cases, GATr substantially outperforms both non-geometric and equivariant baselines.

A brief overview of geometric algebra (GA) is provided. Whereas a plain vector space such as [symbol] ³ allows one to take linear combinations of elements x and y (vectors), a geometric algebra additionally has a bilinear associative operation (e.g., the geometric product, which can be denoted as xy). By multiplying vectors, so-called multivectors can be obtained. The multivectors can represent both geometrical objects and operators. Like vectors, multivectors have a notion of direction as well as magnitude and orientation (sign) and can be linearly combined.

Multivectors can be expanded on a multivector basis, including products of basis vectors. For example, in a 3D GA with orthogonal basis e₁, e₂, e₃, a general multivector takes the form

$$x = {x}_{s} + {x}_{1} {e}_{2} + {x}_{2} {e}_{2} + {x}_{3} {e}_{3} + {x}_{12} {e}_{1} {e}_{2} + {x}_{13} {e}_{1} {e}_{3} + {x}_{23} {e}_{2} {e}_{3} + {x}_{123} {e}_{1} {e}_{2} {e}_{3} , \qquad ( 1 )$$

with real coefficients (xₛ, x₁, . . . , x₁₂₃)∈ [symbol] ⁸. Thus, similar to how a complex number a+bi is a sum of a real scalar and an imaginary number, a general multivector is a sum of different kinds of elements. Indeed, the imaginary unit i can be thought of as the bivector e₁e₂ in a 2D GA. These are characterized by their dimensionality (grade), such as scalars (grade 0), vectors eᵢ (grade 1), bivectors eᵢeⱼ (grade 2), all the way up to the pseudoscalar e₁ . . . e_{d} (grade d).

The geometric product is characterized by the fundamental equation vv= [symbol] v, v [symbol] , where [symbol] ⋅.⋅ [symbol] is an inner product. In other words, one can require that the square of a vector is its squared norm. In an orthogonal basis, where [symbol] eᵢ, eⱼ [symbol] ≢δᵢⱼ, one can deduce that the geometric product of two different basis vectors is antisymmetric: eᵢeⱼ=−eⱼeᵢ. The antisymmetry can be derived by using v²= [symbol] v, v [symbol] to show that eᵢeⱼ+eⱼeᵢ=(eᵢ+eⱼ)²−eᵢ²−eⱼ²=0. Since reordering only produces a sign flip, one can only get one basis multivector per unordered subset of basis vectors, and so the total dimensionality of a GA is

$${\sum }_{i = 0}^{d} ( \begin{matrix}d \\ k\end{matrix} ) = {2}^{d} .$$

Moreover, using bilinearity and the fundamental equation one can compute i=0 k the geometric product of arbitrary multivectors.

The symmetric and antisymmetric parts of the geometric product are called the interior and exterior (wedge) product. For vectors x and y, these are defined as [symbol] x,y [symbol] =(xy+yx)/2 and x∧y [symbol] (xy−yx)/2. The former is indeed equal to the inner product used to define the GA, whereas the latter is new notation. Whereas the inner product computes the similarity, the exterior product constructs a multivector (called a blade) representing the weighted and oriented subspace spanned by the vectors. Both operations can be extended to general multivectors.

The final primitive of the geometric algebra is the dualization operator x [symbol] x*. It acts on basis elements by swapping “empty” and “full” dimensions, e. g. sending e₁ [symbol] e₂₃.

Another concept is the use of projective geometric algebra. In order to represent three-dimensional objects as well as arbitrary rotations and translations acting on them, 3-dimensional (3D) geometric algebra may not be enough. For example, multivectors of 3D geometric algebra can only represent linear subspaces passing through the origin as well as rotations around it. A common technique for expanding the range of objects and operators is to embed the space of interest (e.g. [symbol] ³) into a higher dimensional space whose multivectors represent more general objects and operators in the original space.

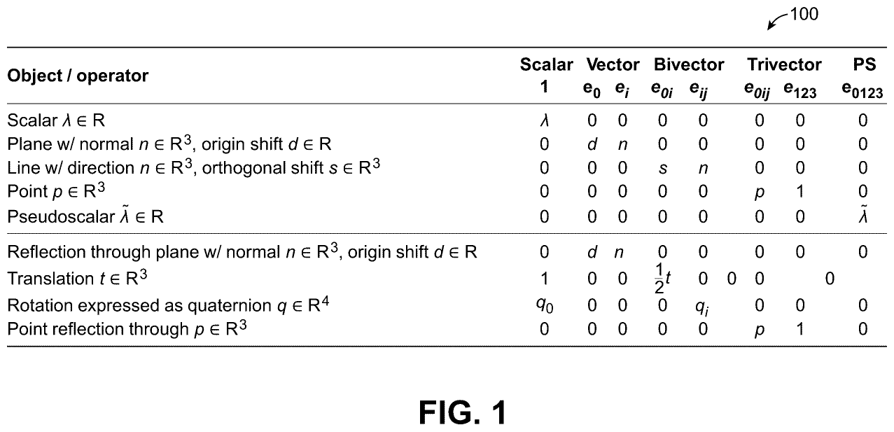

FIG. 1 illustrates a table 100 providing an example dictionary of the embeddings. The embeddings shown in the table 100 illustrate embeddings of common geometric objects and transformations into the projective geometric algebra [symbol] _{3,0,1}. The columns show different components of the multivectors with the corresponding basis elements, with i,j∈{1,2,3}, j≠i, i.e. ij∈{12,13,23}. For simplicity, one can fix gauge ambiguities (the weight of the multivectors) and leave out signs (which depend on the ordering of indices in the basis elements).

In some aspects, the multivector is 1 unit with 16 numbers. The 16-dimensional vector is structured such that each of the components of the vector has a particular type associated with it. A first property of the multivector is that each component can be of a particular type of data. For example, the first number may be a scalar number that could be any number that does not have a direction or location. The next three components can be a regular 3-dimensional vector. There are several particular properties that apply to the structure. The first is that there is a well-established dictionary regarding how to represent different geometric objects. In other words, there can be a rule for how to represent the position of an object. There may be another rule for how to represent object orientations and there can be rules for representing directions, lines, planes, and also for operators acting on objects like translations or rotations.

A second property of the multivector is that there is one operation between the vectors known as the geometric product. The geometric product is a convenient operation because it allows for the computation of the typical operations that would be computed between geometric data with just a single operation. For example, the geometric product between two multivectors that each represent the coordinates of a point will identify the distance between the points. In another example, the geometric product between the representational point and that of a translation vector will identify how to shift the point by the amount of the translation vector. The geometric product is one operation that implements a lot of typical geometric operations.

A scalar product between two vectors provides a single number and a cross product between two vectors provides another vector. Both of these operations are generalized in geometric algebra and in the geometric product between multivectors. The geometric product maps two multivectors into another multivector and the output contains both the typical scalar product and the typical cross product.

Therefore, using the multivector structure as the data representation as described herein and using the geometric product as an operation between multivectors is part of the underlying idea of the geometric algebra transformer. The result is one data type and an associated standard operation that can essentially describe all the data types and operations that are expected to occur often in a three-dimensional environment. With few parameters in the neural network, the system can learn typical operations easily.

As noted previously, systems and techniques described herein provide a geometric algebra transformer (GATr) as part of a neural network architecture or model. The GATr can operate with the projective geometric algebra [symbol] _{3,0,1}. For example, a fourth homogeneous coordinate x₀e₀ can be added to the vector space, yielding a 2⁴=16-dimensional geometric algebra. The metric of [symbol] _{3,0,1} is such that e₀²=0 and eᵢ²=1 for i=1, 2, 3. In the setup the 16-dimensional multivectors can represent 3D points, lines, and planes, which need not pass through the origin, and arbitrary rotations, reflections, and translations in [symbol] ³.

Another concept relates to representing transformations. In geometric algebra, a vector u can act as an operator, reflecting other elements in the hyperplane orthogonal to u. Since any orthogonal transformation is equal to a sequence of reflections, this allows one to express any such transformation as a geometric product of (unit) vectors, called a (unit) versor u=u₁ . . . uₖ. Furthermore, since the product of unit versors is a unit versor, and unit vectors are their own inverse (u²=1), the product of unit versors form a group called the Pin group associated with the metric. Similarly, products of an even number of reflections form a Spin group. In the projective geometric algebra [symbol] _{3,0,1}, the Spin group include the double cover of E(3) and SE(3), respectively. The double cover means that, for each element of E(3), there are two elements of Pin(3, 0, 1), e. g. both the vector v and −v represent the same reflection. Any rotation, translation, and mirroring—the symmetries of three-dimensional space—can thus be represented as [symbol] _{3,0,1} multivectors.

In order to apply a versor u to an arbitrary element x, one uses the sandwich product:

$${p}_{u} ( x ) = \{ \begin{matrix}{uxu}^{- 1} & if u is even \\ u \hat{x} {u}^{- 1} & if u is odd\end{matrix} \qquad ( 2 )$$

Here \hat{x} is the grade involution, which flips the sign of odd-grade elements such as vectors and trivectors, while leaving even-grade elements unchanged. Equation 2 thus gives a linear action (i. e. group representation) of the Pin and Spin groups on the 2^{d}-dimensional space of multivectors. The sandwich product is grade-preserving, so this representation splits into a direct sum of representations on each grade.

The systems and techniques described herein can represent 3D objects by representing planes with vectors. The systems and techniques can require that the intersection of two geometric objects is given by the wedge product of their representations. Lines (the intersection of two planes) can be represented as bivectors and points (the intersection of three planes) can be represented as trivectors. Such 3D object representations can lead to a duality between objects and operators, where objects are represented like transformations that leave them invariant. As described previously, table 100 in FIG. 1 provides a dictionary of these embeddings. It is easy to check that this representation is consistent with using the sandwich product for transformations.

For the concept of equivariance, one can construct network layers that are equivariant with respect to E(3), or equivalently its double cover Pin(3,0,1). A function ƒ: [symbol] _{3,0,1}→ [symbol] _{3,0,1} is Pin(3, 0, 1)-equivariant with respect to the representation ρ (or Pin(3, 0, 1)-equivariant for short) if

$$f ( {ρ}_{u} ( x ) ) = {ρ}_{u} ( f ( x ) ) \qquad ( 3 )$$

for any u∈Pin(3, 0, 1) and x∈ [symbol] _{3,0,1}, where ρᵤ(x) is the sandwich product defined in Eq. (2).

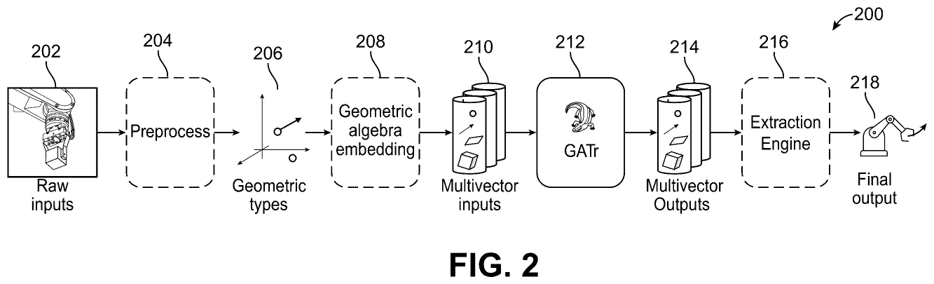

FIG. 2 illustrates a neural network model 200 that includes various components including an example of a geometric algebra transformer (GATr) network 212 described herein. If necessary, raw inputs are first preprocessed into geometric types. The geometric objects are then embedded into multivectors of the geometric algebra [symbol] _{3,0,1}, following the recipe described in FIG. 1.

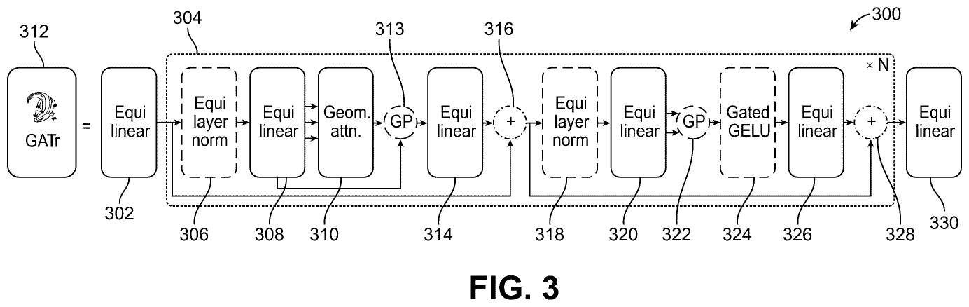

The multivector-valued data are processed with the GATr network 212. FIG. 3 illustrates the GATr network 212 architecture in more detail. The GATr network 212 includes N transformer blocks, each including of an equivariant multivector LayerNorm, a geometric attention layer 310 (e.g., an equivariant multivector self-attention layer), a residual connection, another equivariant LayerNorm, an equivariant multivector MLP with geometric bilinear interactions, and another residual connection. The architecture is adapted to correctly handle multivector data and be E(3) equivariant. These various components are discussed in more detail when FIG. 3 is introduced below.

The GATr network 212 is a general-purpose network architecture for geometric data. Raw input data 202 can be received from any three-dimensional context such as an image, a point cloud, a video, and/or other data related to a task in three-dimensions. A pre-processing engine 204 processes the data to generate geometric types 206. The pre-processing may or may not be necessary depending on the structure of the raw inputs. In some aspects, the pre-processing engine 204 can parse pixels of images from one or more cameras into positions and velocities of one or more objects in the images. Additionally or alternatively, the pre-processing engine 204 can process locations of objects, orientation of objects, and/or a direction of movement of objects in a three-dimensional space.

A geometric algebra embedding engine 208 can generate multivector inputs 210 (also referred to as multivectors) using the geometric types 206. For example, the geometric algebra embedding engine 208 can embed the geometric types 206 (e.g., the geometric properties of the input data) into multivector representations of the multivector inputs 210. In some aspects, the multivector inputs 210 can be generated from a geometric product of vectors. Additionally or alternatively, the multivector inputs 210 can be a representation of geometric objects and operators associated with the geometric objects. In some aspects, the geometric algebra embedding engine 208 can embed the geometric objects into multivectors of geometric algebra [symbol] _{3,0,1}, which can result in the multivector inputs 210.

The GATr network 212 can receive the multivector inputs 210. Based on performing equivariant processing of the geometric algebra representations embodied in the multivector inputs 210, GATr network 212 can generate multivector outputs 214. An extraction engine 216 can extract geometric objects (e.g., based on geometric algebra) from the multivector outputs 214 to obtain a final output 218. The final output 218 can be used to perform a task, such as control movement of a robotic component (e.g., a robotic arm).

In some cases, the multivector outputs 214 can include data such as an orientation and/or a movement of a robotic arm. In one example, the raw input data 202 can include multiple camera images which can be used to identify a current position of a robotic arm, a block, a location of the block and a location where the block needs to be moved. The multivector outputs 214 may include data regarding an orientation or a movement of the robotic arm (such as through a vector or a direction of movement) in order to achieve the task. The neural network model 200 can extract features or other information from the multivector output 214 to perform the task. For example, in a reinforcement learning situation, the system can extract a next action from the multivector output 214. In another example, in the event the problem being addressed by the neural network model 200 is a regression problem, the neural network model 200 can extract a subject of the regression problem.

In some aspects, the task is to stack a set of blocks. The raw input data 202 data can identify a current position of a robotic arm and a current position of four blocks on a table. The output 214 may include how the robotic arm needs to move to grab one block at a time and stack the blocks. The output 214 represents the movement for the robot and may include data types not found in the input, such as vectors that represent a rotational value or a translation value associated with the movement the robot needs to achieve to stack the blocks or perform the task.

The design of GATr network 212 follows from various design principles. One principle is a geometric inductive bias through geometric algebra representations. The GATr network 212 can be designed to provide a strong inductive bias for geometric data. The GATr network 212 should be able to represent different geometric objects and their transformations, for instance points, lines, planes, translations, rotations, and so on. In addition, the GATr network 212 should be able to represent common interactions between these types with few layers, and be able to identify them from little data (while maintaining the low bias of large transformer models). Examples of such common patterns include computing the relative distances between points, applying transformations to objects, or computing the intersections of planes and lines.

This disclosure proposes that geometric algebra provide a language that is well-suited to a task. One can use the projective geometric algebra [symbol] _{3,0,1} and use the plane-based representation of geometric structure outlined above.

Another design principle is symmetry awareness through E(3) equivariance. The architecture of the GATr network 212 should respect the symmetries of 3D space. Therefore, the GATr network 212 is equivariant with respect to the symmetry group E(3) of translations, rotations, and reflections.

Note that the projective geometric algebra naturally offers a faithful representation of E(3), including translations. One can thus represent objects that transform arbitrarily under E(3), including with respect to translations of the inputs. This is in stark contrast with most E(3)-equivariant architectures, which only use O(3) representations and whose features only transform under rotation. Those architectures must handle points and translations in hand-crafted ways, like by canonicalizing with respect to the center of mass or by treating the difference between points as a translation-invariant vector.

Many systems will not exhibit the full E(3) symmetry group. The direction of gravity, for instance, often breaks it down to the smaller E(2) group. To maximize the versatility of the GATr network 212, one can choose to develop a E(3)-equivariant architecture and to include symmetry-breaking as part of the network inputs, similar to how position embeddings break permutation equivariance in transformers.

Another design principle is scalability and flexibility through dot-product attention. The GATr network 212 can be expressive, easy to train, efficient, and scalable to large systems. The GATr network 212 should also be as flexible as possible, supporting variable geometric inputs and both static scenes and time series.

These design principles can cause one to implement the GATr network 212 as a transformer, based on attention over multiple objects (similar to tokens in a multilayer perceptron (MLP) or image patches in computer vision). The choice of using a transformer makes the GATr network 212 equivariant also with respect to permutations along the object dimension. As in standard transformers, one can break this equivariance when desired (in particular, along time dimensions) through positional embedding.

The GATr network 212 can be based on a dot-product attention mechanism, for which heavily optimized implementations exist. The GATr network 212 can be scaled to problems with many thousands of tokens, much further than equivariant architectures based on graph neural networks and message-passing algorithms.

In some aspects, a multilayer perceptron (MLP) is a fully connected class of feedforward artificial neural network (ANN). The term MLP can mean any feedforward ANN. In other cases, MLP can strictly refer to networks composed of multiple layers of perceptrons (with threshold activation). MLPs are sometimes referred to as “vanilla” neural networks, especially when they have a single hidden layer.

An MLP can include at least three layers of nodes: an input layer, a hidden layer and an output layer. Except for the input nodes, each node is a neuron that uses a nonlinear activation function. MLPs can utilize a chain rule based supervised learning technique called backpropagation or reverse mode of automatic differentiation for training. Its multiple layers and non-linear activation distinguish MLP from a linear perceptron. It can distinguish data that is not linearly separable.

FIG. 3 illustrates an example of an architecture 300 of a GATr network 312. Note that within FIG. 2 and FIG. 3, boxes with solid lines are learnable components. Boxes with dashed lines are fixed components. As shown, the architecture 300 includes of the GATr network 312 includes components, including an input equilinear layer 302 and N transformer blocks 304. Each of the N transformer blocks 304 includes a first normalization layer 306 (e.g., a first equivariant multivector normalization layer, which may be implemented as a LayerNorm), a first equilinear layer 308, a geometric attention layer 310 (e.g., an equivariant multivector self-attention layer), a first geometric product engine 313 (or layer), a second equilinear layer 314, a first addition engine 316 (e.g., a first residual connection), a second normalization layer 318 (e.g., a second equivariant multivector normalization layer, which may be implemented as a LayerNorm), a third equilinear layer 320, a second geometric product engine 322 (or layer), a scalar-gated nonlinearity layer 324, a fourth equilinear layer 326, and a second addition engine 328 (e.g., a second residual connection). In some cases, the various components may be used in a typical transformer with pre-layer normalization, and may be adapted to handle multivector data and be E(3) equivariant as described herein. In some aspects, one or more of the first normalization layer 306, the first geometric product engine 313, the first addition engine 316, the second normalization layer 318, the second geometric product engine 322, the scalar-gated nonlinearity layer 324, and the second addition engine 328 may be fixed components. In some aspects, one or more of the first equilinear layer 308, the geometric attention layer 310, the second equilinear layer 314, the third equilinear layer 320 and the fourth equilinear layer 326 can be learnable components.

As described previously, the GATr network 312 can process a multivector input (e.g., multivector inputs 210 of FIG. 2), such as multivector-valued data (e.g., similar to the GATr network 212 of FIG. 2). Based on the output from the GATr network 312, the architecture 300 can extract geometric objects of interest (e.g., geometric objects of interest extracted by the extraction engine 216 of FIG. 2). For example, according to some aspects, the input equilinear layer 302 can receive and process multivector inputs (e.g., the multivector inputs 210 of FIG. 2) and can generate an input equilinear layer output. The input equilinear layer output can be provided to a transformer block from the N transformer blocks 304. The first normalization layer 306 in the transformer block receives the input equilinear layer output and generates a first normalization layer output. The first equilinear layer 308 in the transformer block 304 receives the first normalization layer output and generates a first equilinear layer output. The geometric attention layer 310 receives the first equilinear layer output and generates a geometric attention layer output. The first geometric product engine 313 receives the geometric attention layer output and the first equilinear layer output and generates a first geometric product engine output. The second equilinear layer 314 receives the first geometric product engine output and generates a second equilinear layer output. The first addition engine 316 adds the second equilinear layer output to the input equilinear layer output to generate a first addition output or first addition output.

The second normalization layer 318 receives the first addition output or first addition output and generates a second normalization layer output. The third equilinear layer 320 receives the second normalization layer output and generates a third equilinear layer output. The second geometric product engine 322 receives the third equilinear layer output and generates a second geometric product engine output. The scalar-gated nonlinearity layer 324 receives the second geometric product engine output and generates a scalar-gated nonlinearity layer output. The fourth equilinear layer 326 receives the scalar-gated nonlinearity layer output and generates a fourth equilinear layer output. The second addition engine 328 adds the fourth equilinear layer output to the first addition output to generate a second addition output. The output equilinear layer 330 receives the second addition output and can then generate multivector outputs (e.g., multivector outputs 214 of FIG. 2).

Various primitives can be used for the GATr network (e.g., the GATr network 212 of FIG. 2 and/or the GATr network 312 of FIG. 3. In some cases, linear layers between multivectors can be used. The equivariance condition of Eq. (3) can constrain the linear layers. For example, a linear map ϕ: [symbol] _{d,0,1}→ [symbol] _{d,0,1} that is equivariant to Pin(d, 0, 1) can be in the following form:

$$ϕ ( x ) = {\sum }_{k = 0}^{d + 1} {w}_{k} 〈 x {〉}_{k} + {\sum }_{k = 0}^{d} {v}_{k} {e}_{0} 〈 x {〉}_{k} \qquad ( 4 )$$

for parameters w∈ [symbol] ^{d+2}, v∈ [symbol] ^{d+1}. Here [symbol] x [symbol] ₖ is the blade projection of a multivector, which sets all non-grade-k elements to zero.

According to Equation (4), E(3)-equivariant linear maps between [symbol] _{3,0,1} multivectors can be parameterized with nine coefficients, five of which are the grade projections and four include a multiplication with the homogeneous basis vector e₀. One can thus parameterize affine layers between multivector-valued arrays with Eq. (4), with learnable coefficients wₖ and vₖ for each combination of input channel and output channel. In addition, there is a learnable bias term for the scalar components of the outputs (biases for the other components are not equivariant). While the number of coefficients in one aspect is nine, other numbers of coefficients can be used as well.

Geometric bilinears can also be used for the GATr network. For instance, equivariant linear maps are not sufficient to build expressive networks. The reason is that these operations allow for only very limited grade mixing, as shown above. For the GATr network to be able to construct new geometric features from existing features, such as the translation vector between two points, additional primitives (e.g., geometric primitives) can be utilized. For example, a first primitive that can be used the GATr network includes a geometric product x, y [symbol] xy, which is a bilinear operation of geometric algebra. The geometric product allows for substantial mixing between grades. For instance, the geometric product of vectors includes scalars and bivector components. The geometric product is equivariant. A second primitive that can be used by the GATr network can be derived from the so-called join x,y [symbol] (x*∧y*)*. The join operation has an anti-dual (not a dual) in the output. The GATr network, for equivariance purposes and for expressivity, can utilize either the anti-dual or dual output, as any equivariant linear layer can transform between the two. A resulting equivariant map can thus include the dual x [symbol] x*. Including the dual in an architecture of the GATr network can be useful for expressivity: in [symbol] _{3,0,1}. For example, without dualization, it may not be possible to represent even simple functions such as the Euclidean distance between two points. While the dual itself is not Pin(3, 0, 1)-equivariant (with respect to ρ), the join operation is equivariant to even (non-mirror) transformations. To make the join equivariant to mirrorings as well, one can multiply its output with a pseudoscalar derived from the network inputs: x, y, z [symbol] EquiJoin(x, y; z)=z₀₁₂₃(x*∧y*)*, where z₀₁₂₃∈ [symbol] is the pseudoscalar component of a reference multivector z.

A geometric bilinear layer can be used that combines the geometric product and the join of the two inputs as Geometric(x, y; z)=Concatenate_{channels}(xy, EquiJoin(x, y; z)). In the GATr network, the layer is included in the MLP.

The GATr network can include various nonlinearities and normalization operations. In some aspects, scalar-gated Gaussian Error Linear Unit (GELU) nonlinearities GatedGELU(x)=GELU(x₁)x, can be used, where x₁ is the scalar component of the multivector x. Moreover, an E(3)-equivariant LayerNorm operation can be defined for multivectors as LayerNorm

$$( x ) = x / \sqrt{{𝔼}_{c} 〈 x , x 〉} ,$$

where the expectation goes over channels and one can use the invariant inner product [symbol] ⋅,⋅ [symbol] of [symbol] _{3,0,1}.

The GATr network also uses attention in one or more layers. In some aspects, given multivector-valued query, key, and value tensors, each including nᵢ items (or tokens) and n_{c} channels (key length), the E(3)-equivariant multivector attention can be defined, for example as follows:

$$Attention {( q , k , v )}_{{i}^{′} {c}^{′}} = {\sum }_{i} {Soft max}_{i} ( \frac{{\sum }_{c} 〈 {q}_{{i}^{′} c} , {k}_{ic} 〉}{\sqrt{8 {n}_{c}}} ) {v}_{{ic}^{′} .} \qquad ( 5 )$$

Here, the indices i, iⁱ label items, c, cⁱ label channels, and [symbol] ⋅,⋅ [symbol] is the invariant inner product of the geometric algebra. The approach disclosed herein computes scalar attention weights with a scaled dot product. The difference is that one can use the inner product of [symbol] _{3,0,1}. One can also use attention mechanisms that apply the geometric product rather than the dot product. Since this dot product of [symbol] _{3,0,1} only depends on 8 out of 16 multivector dimensions, one can scale the inner product by \sqrt{8n_{c}} rather than \sqrt{16n_{c}} as one would do in a conventional transformer with key dimension dₖ=16n_{c}. Despite this difference, one can build on highly efficient implementations of dot-product attention. As can be demonstrated, the approach allows us to scale the GATr network to systems with many thousands of tokens. One can extend this attention mechanism to multi-head self-attention in the usual way.

In some cases, auxiliary scalar representations (e.g., in addition to multivector representations) can be used. For instance, while multivectors can be well-suited to model geometric data, many problems contain non-geometric information as well. Such scalar information may be high-dimensional, for instance in sinusoidal positional encoding schemes. Rather than embedding into the scalar components of the multivectors, one can add an auxiliary scalar representation to the hidden states of the GATr network. Each layer thus has both scalar and multivector inputs and outputs. The layers have the same batch dimension and item dimension, but may have different number of channels.

The additional scalar information may interact with the multivector data in various ways. In linear layers, the GATr network can be designed so that auxiliary scalars mix with the scalar component of the multivectors. An attention layer of the GATr network (e.g., the geometric attention layer 310 of FIG. 3) can compute attention weights from the multivectors (e.g., as given in Eq. (5)) and from the auxiliary scalars (e.g., using scaled dot-product attention, such as by the first geometric product engine 313 of FIG. 3), resulting in two attention maps. The two attention maps can be summed (e.g., by the first addition engine 316 of FIG. 3) before performing normalization (e.g., by the second normalization layer 318 and/or third equilinear layer 320 of FIG. 3), such as using Softmax. In some cases, a normalizing factor of the normalization is adapted. In other layers of the GATr network, the scalar information can be processed separately from the multivector information, using the unrestricted form of the multivector map. For instance, nonlinearities can transform multivectors with equivariant gated GELUs and auxiliary scalars with regular GELU functions.

As noted above, in addition to multivector representations, GATr supports auxiliary scalar representations. For instance, GATr can use auxiliary scalar representations to describe non-geometric side information such as positional encodings or diffusion time embeddings. In some layers (e.g., most layers) of the GATr neural network architecture, the scalar variables can be processed as in a standard transformer, with two exceptions. For some examples, as noted above, the scalar components of multivectors and the auxiliary scalars are allowed to freely mix in the linear layers. In such examples, In the attention operation, the attention weights can be computed as follows:

$${Soft max}_{i} ( \frac{{\sum }_{c} 〈 {q}_{{i}^{′} c}^{MV} , {k}_{ic}^{MV} 〉 + {\sum }_{c} {q}_{{i}^{′} c}^{s} {k}_{ic}^{s}}{\sqrt{8 {n}_{MV} + {n}_{s}}} ) \qquad ( 6 )$$

Where q^{MV} and k^{MV} are query and key multivector representations, respectively, q^{s} and k^{s} are query and key scalar representations, respectively, n_{MV} is the number of multivector channels, and nₛ is the number of scalar channels.

The distance-aware dot-product attention is discussed next. The dot-product attention in Eq. (5) takes into account only half of the components of the multivectors (including those that do not involve the basis element e₀), as a straightforward Euclidean inner product with those components would violate equivariance. One can, however, extend the attention mechanism to incorporate more components, while still maintaining E(3) equivariance and the computational efficiency of dot-product attention. For instance, queries and keys can be extended with nonlinear features. To this end, one can define certain auxiliary, non-linear query features ϕ(q) and key features Ψ(k) and extend the attention weights in Eq. (5) as [symbol] q_{i′c}, k_{ic} [symbol] → [symbol] q_{i′c}, k_{ic} [symbol] +ϕ(q_{i′c})·ψ(k_{ic}), adapting the normalization appropriately.

For example, to extend queries and keys with nonlinear features the following can be used:

$$ϕ ( q ) = \frac{{q}_{∖ 0}}{{q}_{∖ 0}^{2} + ϵ} ( \begin{matrix}\begin{matrix}{q}_{∖ 0}^{2} \\ {\sum }_{i} {q}_{∖ i}^{2}\end{matrix} \\ {q}_{∖ 0} {q}_{∖ 1} \\ {q}_{∖ 0} {q}_{∖ 2} \\ {q}_{∖ 0} {q}_{∖ 3}\end{matrix} ) and ψ ( k ) = \frac{{k}_{∖ 0}}{{k}_{∖ 0}^{2} + ϵ} ( \begin{matrix}- {\sum }_{i} {k}_{∖ i}^{2} \\ - {k}_{∖ 0}^{2} \\ 2 {k}_{∖ 0} {k}_{∖ 1} \\ 2 {k}_{∖ 0} {k}_{∖ 2} \\ 2 {k}_{∖ 0} {k}_{∖ 3}\end{matrix} ) \qquad ( 7 )$$

where the index \i denotes the trivector component with all indices but i. The following can then be determined:

$$ϕ ( {q}_{{i}^{′} c} ) \cdot ψ ( {k}_{ic} ) ∝ - {( {k}_{∖ 0} \vec{q} - {q}_{∖ 0} \vec{k} )}^{2} \qquad ( 8 )$$

where the following shorthand is used: \vec{x}=(x_{\1}, x_{\2}, x_{\3})^{T}.

This additional contribution to the attention weights is E(3)-invariant. When the trivector components of queries and keys represent 3D points, it becomes proportional to the pairwise negative squared Euclidean distance between the points. With the additional contribution, the attention mechanism of GATr computes attention weights from three sources, including the [symbol] _{3,0,1} inner product of the multivector queries and keys [symbol] q, k [symbol] , the distance-aware inner product of the nonlinear features ϕ(q)·ψ(k), and the Euclidean inner product of the auxiliary scalars qₛ·kₛ. In some cases, it can be beneficial to add learnable weights as prefactors to each of the three terms. The attention weights can then be given by the following:

$${Soft max}_{i} ( \frac{α {\sum }_{c} 〈 {q}_{{i}^{′} c}^{MV} , {k}_{ic}^{MV} 〉 + β {\sum }_{c} ϕ ( {q}_{{i}^{′} c}^{MV} ) \cdot ψ ( {k}_{ic}^{MV} ) + γ {\sum }_{c} {q}_{{i}^{′} c}^{s} {k}_{ic}^{s}}{\sqrt{13 {n}_{MV} + {n}_{s}}} ) \qquad ( 9 )$$

with learnable, head-specific α, β, γ>0. All terms in equation (9) can be summarized in a single Euclidean dot product between query features and key features. Efficient implementations of dot product attention to compute GATr attention. In some cases, to reduce memory use, a version of GATr that uses multi-query attention can be used instead of multi-head attention, sharing the keys and values among attention heads.

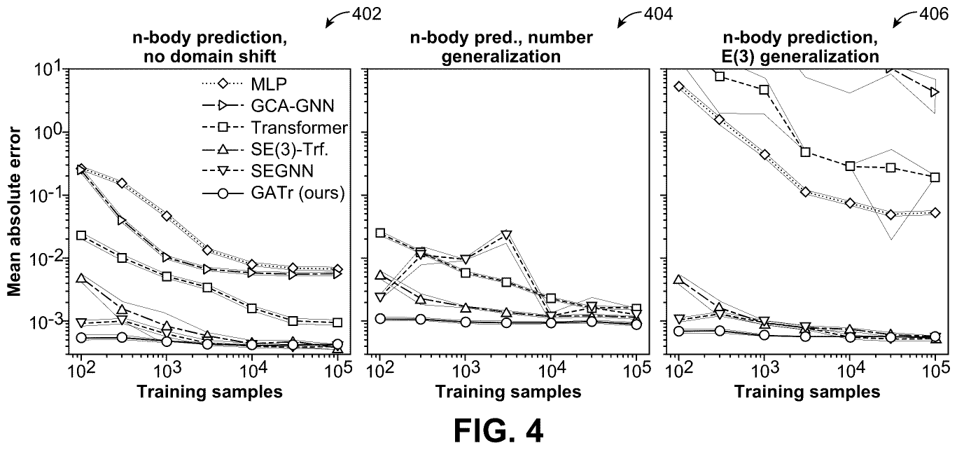

FIG. 4 includes a first graph 402, a second graph 404, and a third graph 406 illustrating various n-body dynamics experimental results. The results show the error in predicting future positions of planets as a function of the training dataset size. Out of five independent training runs, the mean and standard error are shown. A first graph 402 represents evaluating without distribution shift. The GATr network is more sample efficient than the equivariant SEGNN (Steerable E(3) graph neural network) and the SE(3)-Transformer and outperforms non-equivariant baselines. The second graph 404 illustrates an evaluation on systems with more planets than trained on. Transformer architectures generalize well to different object counts. The GCA-GNN (graph contrastive learning—graph neural network) has larger errors than the visible range. The third graph 406 illustrates results of an evaluation on translated data. Because the GATr network is E(3) equivariant, it generalizes under the domain shift.

The choice of these nonlinear features not only guarantees equivariance, but has a geometric intuition. When the trivector components of queries and keys represent 3D points (see Tbl. 1), ψ(q)·ϕ(k) is proportional to the pairwise negative squared Euclidean distance. The attention mechanism of the GATr network is therefore directly sensitive to Euclidean distance, while still respecting the highly efficient dot-product attention format.

In some cases, the GATr network can utilize positional embeddings. For instance, the GATr network can assume that the data can be described as a set of items (or tokens). If these items are distinguishable and form a sequence, one can encode their position using “rotary positional” embeddings in the auxiliary scalar variables. The terminology, which stems from non-geometric transformers, can be confusing. “Position” here means position in a sequence, not geometric position in 3D. “Rotary” does not refer a rotation of 3D space, but rather to how the position in a sequence is embedded via sinusoids in the scalar channels of keys and queries. Using positional encoding thus does not affect E(3) equivariance. Since auxiliary scalar representations and multivectors mix in the attention mechanism, the positional embeddings also affect the multivector processing.

Axial attention can also be used. The architecture can be flexible about the structure of the data. In some use cases, there will be a single dimension along which objects are organized, for instance when describing a static scene or the time evolution of a single object. But the GATr network also can support the organization of a problem along multiple axes, for example with one dimension describing objects and another time steps. In this case, one can follow an axial transformer layout, alternating between transformer blocks that attend over different dimensions. The not-attended dimensions in each block can be treated like a batch dimension.

As described herein, the GATr network provides a general-purpose machine learning (e.g., neural network) architecture for geometric data. Experiments demonstrate that GATr network effectively combines structure and scalability. The GATr network can represent geometric structures by representing data in projective geometric algebra, as well as through E(3) equivariance. Unlike existing equivariant neural network architectures, the GATr network described herein can generate faithful E(3) representations, including absolute positions and equivariance with respect to translations. As described below, the GATr network outperforms non-geometric, equivariant, and geometric algebra-based non-equivariant baselines across three experiments. The GATr network also scales better than existing geometric networks, at least in part because the GATr network includes at least one transformer and computes pairwise interactions through one or more attention mechanism (e.g., dot-product attention).

In particular, the GATr network provides various improvements as compared to existing neural network models. For instance, an empirical demonstration of the GATr network with an n-body dynamics problem can be used to compare GATr network to a wide range of baseline neural network models. The first graph 402 of FIG. 4 illustrates a prediction error as a function of the number of training samples used. As illustrated by the first graph 402. the GATr network outperforms various non-equivariant baselines, including a network including a transformer and an MLP (shown as “MLP), an equivariant Steerable E(3) graph neural network (SEGNN), an SE(3)-Transformer, and a geometric-algebra-based, but not equivariant, GCA-GNN. Compared to the equivariant SEGNN and SE(3)-Transformer, GATr network is more sample-efficient.

The GATr network also generalizes robustly outside of a domain of the training data used to train the GATr network, as is shown in the second graph 404 and the third graph 406. When evaluating on a larger number of bodies than trained on, methods that use a Softmax over attention weights (GATr, Transformer, SE(3)-Transformer) generalize best. Finally, the performance of the E(3)-equivariant GATr, SEGNN, and SE(3)-Transformer does not drop when evaluated on spatially translated data. while the non-equivariant baselines fail in the setting.

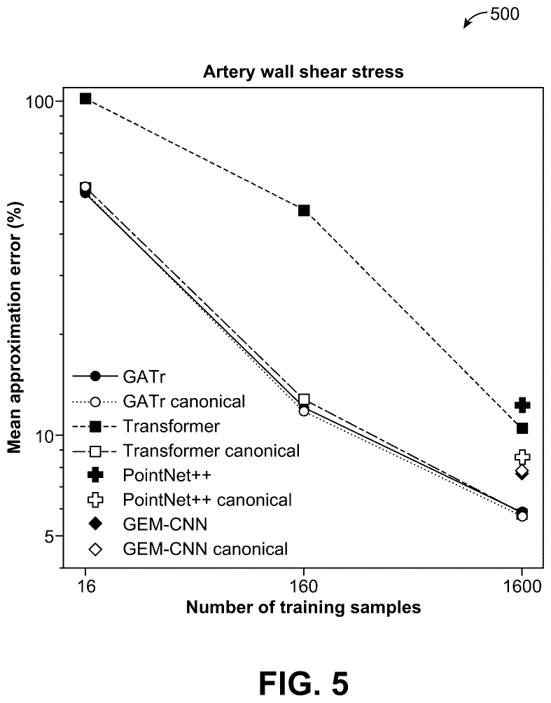

FIG. 5 includes a graph 500 illustrative results of an experiment involving complex geometric objects. In particular, the experiment associated with the graph 500 includes a prediction of wall shear stress exerted by blood flow on an arterial wall, which can be an important predictor of aneurysms. While the wall shear stress can be computed with computational fluid dynamics, simulating a single artery can take many hours, and efficient neural surrogate networks can have substantial impact. However, training such neural surrogate networks can be challenging, as meshes are large (e.g., approximately 7000 nodes in some data) and datasets typically small (e.g., 1600 training meshes in some cases).

The GATr network can be trained on a dataset of arterial meshes and simulated wall shear stress. As illustrated in the graph 500 of FIG. 5, when considering the results without canonicalization and with randomly rotated meshes, the GATr network improves upon the existing models and sets a new state of the art. For arterial wall shear stress estimation, one can show the mean approximation error (lower is better) as a function of training dataset size, reporting results in the graph 500 both on randomly oriented training and test samples (solid markers) and on a version of the dataset in which all artery meshes are canonically oriented (hollow markers). Without canonicalization, the GATr network predicts wall shear stress more precisely and is more sample-efficient than the baselines.

Experiments can also be formed with canonicalization, where the arteries can be rotated such that blood always flows in the same direction. This helps the transformer to be competitive with the GATr network. However, canonicalization is only feasible for relatively straight arteries as in the dataset, not in more complex scenarios with branching and turning arteries. The GATr network should be more robust in such scenarios.

Another experiment can relate to robotic planning through invariant diffusion. As described herein, the GATr network defines an E(3)-invariant diffusion model and can be used for model-based reinforcement learning and planning. Such a combination is well-suited to solve robotics problems. For instance, a diffusion model can be trained on offline trajectories and can be used in a planning loop, such as for sampling as conditioned on the current state, desired future states, or to maximize a given reward, as needed. In some cases, the GATr network can also be used as a denoising network in a diffusion model (e.g., for use in route planning). The combination can be called a GATr-Diffuser. Combining the equivariant GATr with an invariant base density defines an E(3)×Sₙ-invariant diffusion model. The symmetry can be softly broken by conditioning on the current or target state or through reward guidance, if desired.

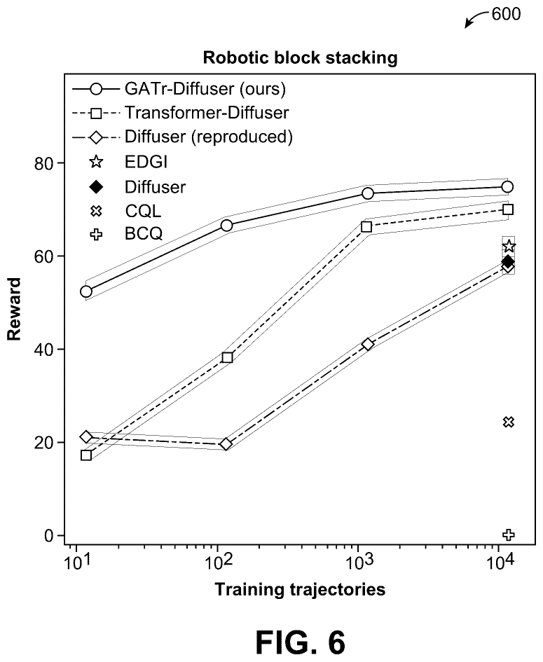

FIG. 6 includes a graph 600 illustrating use of the GATr-Diffuser for addressing a problem of a robotic gripper stacking blocks in an “unconditional” environment. In such an example, the GATr-Diffuser can be trained on an offline trajectory dataset and then used for planning tasks for the robotic gripper. The GATr-Diffuser model is compared to a reproduction of the original diffuser model and a new transformer backbone for the diffuser model. As illustrated in the graph 600, the GATr-Diffuser solves the block-stacking task better than all baselines. The graph 600 also shows that the GATr-Diffuser is more sample-efficient, matching the performance of a diffuser model or transformer trained on the full dataset even when training only on 1% of the trajectories. As further illustrated by the graph 600, the results of diffusion-based robotic planning show improvement. For instance, normalized rewards (where higher is better) are shown as a function of training dataset size. The GATr network is more successful at block stacking and more sample-efficient than the baselines, including the original Diffuser model and a modification of it based on a transformer.

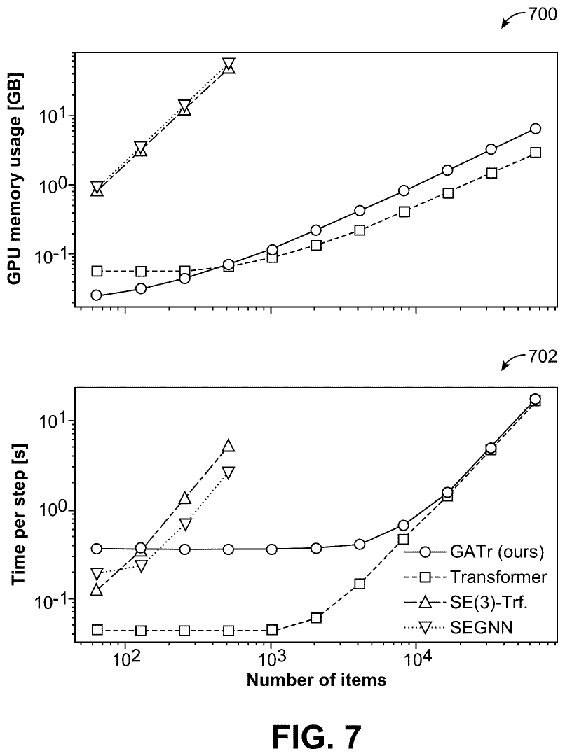

FIG. 7 includes a first graph 700 and a second graph 702 illustrating improved computation requirements and scaling ability of the GATr network as compared to existing neural network models. The computation requirements can include memory usage and compute time of forward and backward passes on synthetic data as a function of a number of items (e.g., a number of tokens). Peak GPU memory usage is illustrated in the first graph 700 and wall time is illustrated in the second graph 702. per combined forward and backward pass as a function of the number of items in synthetic data. In the first and second graphs 700, 702, the GATr network is compared to three other models, including a transformer, the SE(3)-Transformer, and to SEGNN. Hyperparameters can be selected for the architectures of the four models such that they have the same depth and width and require that the methods allow all items to interact at each step (e.g., fully connected graphs). As illustrated by the first graph 700 and the second graph 702, for larger problems (e.g., a large number of items, such as tokens), compute and memory requirements are dominated by the pairwise interactions in the attention mechanism. In such cases, the GATr network performs on par, as it uses efficient implementations of dot-product attention. In terms of memory, the GATr network scales linearly in the number of tokens, while the equivariant baselines scale quadratically. In terms of time, the models scale quadratically, but the equivariant baselines have a worse prefactor than the GATr network and the transformer. The GATr network can thus scale to tens of thousands of tokens, while the equivariant baselines run out of memory two orders of magnitude earlier.

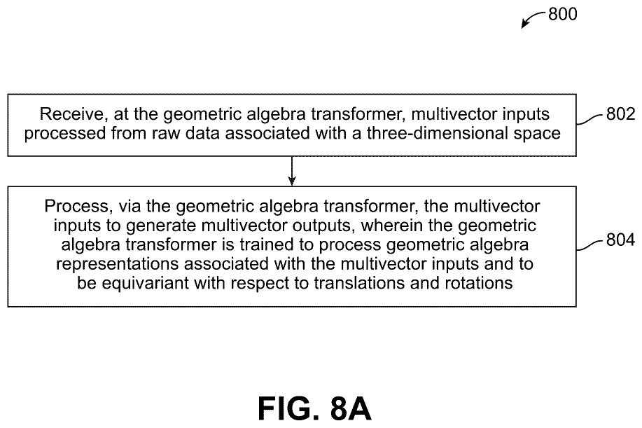

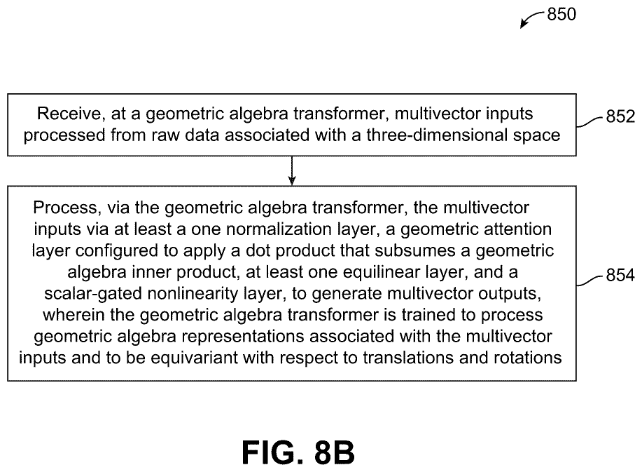

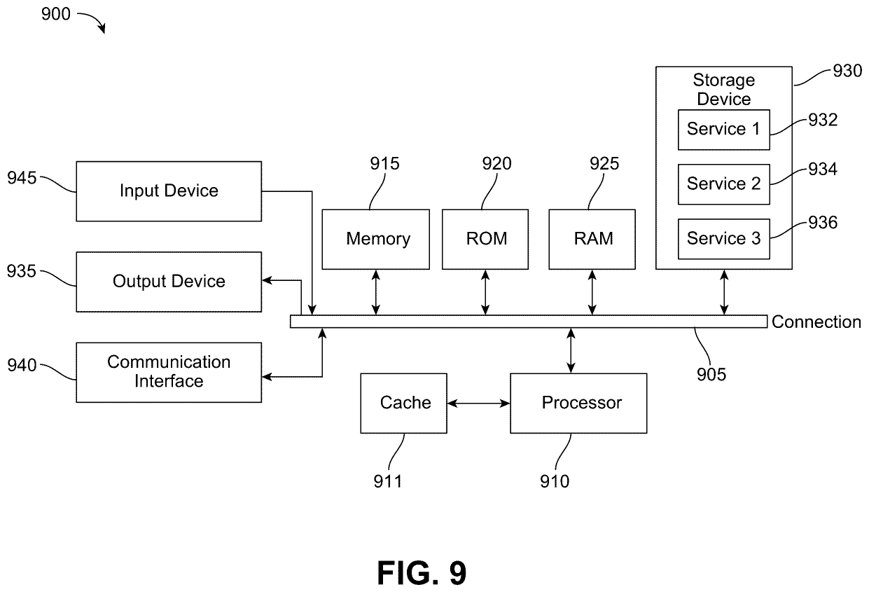

FIG. 8A is a flow diagram illustrating an example process 800 associated with using a geometric algebra transformer (e.g., via the GATr 212 of FIG. 2, the GATr network 312 of FIG. 3, the computing system 900 of FIG. 9 described below, or any one or more subcomponent thereof), according to aspects of the disclosure. At block 802, the process 800 includes receiving, at the geometric algebra transformer (e.g., via the GATr 212 of FIG. 2 and/or the GATr network 312 of FIG. 3), multivector inputs processed from raw data associated with a three-dimensional space. In some cases, the multivector inputs include a scalar value, a plane with a normal value, a line with a direction value, a point value, a pseudoscalar value, a reflection value through a plane with a normal value, a translation value, a rotation value, a point reflection value, any combination thereof, or other inputs. In some aspects, the multivector inputs can include multi-component (e.g., a 16-component) multivectors, although the number of components can vary in the multivector input. In some examples, the multi-component multivectors can include embedded geometric objects. For instance, the embedded geometric objects can be embedded into the multi-component multivectors using a geometric algebra embedding component (e.g., the geometric algebra embedding engine 208 of FIG. 2). In some aspects, the embedded geometric objects can include a scalar, a vector, a bivector, a trivector, a pseudoscalar, any combination thereof, and/or other geometric objects. In some cases, the multi-component multivectors can include mappings between geometric objects and the multi-component multivectors. The multi-component multivectors can be mapped by a geometric algebra embedding engine 208 as shown in FIG. 2.

At block 804, the process 800 includes processing, via the geometric algebra transformer, the multivector inputs to generate multivector outputs. As described herein, the geometric algebra transformer is trained to process geometric algebra representations associated with the multivector inputs and to be equivariant with respect to translations and rotations.

In aspect, the training data for the geometric algebra transformer includes labeled outputs associated with the inputs together with the task or action for which the geometric algebra transformer is trained to performed. The neural network model or other model of the geometric algebra transformer can then be trained based on these training examples to match the inputs to the right outputs. For instance, a human expert can control a robot to perform certain tasks (i.e., moving blocks or stacking blocks) and the system can store the data regarding the original positions and then the movement that was taken. The inputs can be stored together with the movement that the human expert took in each given situation. The result can be a pair of inputs and the desired outputs, and then the geometric algebra transformer can be trained by minimizing a loss function such that the inputs are correctly mapped to the outputs.

In some cases, the geometric algebra transformer may include a neural network model trained to perform a single task or trained to perform multiple different tasks given different inputs. The neural network model may include a single model (e.g., trained to perform a single task or multiple tasks) or multiple models each performing a specific task.

In some aspects, the geometric algebra transformer can be provided with the task to be achieved (e.g., based on user input) or may select the task based on the input data (e.g., based on observing a scene in image data or other input data) and the training of the geometric algebra transformer. In one illustrative example, as part of a task, an input from a user or a system may be the coordinates of where a block next is to be moved by a robotic arm. In another illustrative example, a system including the geometric algebra transformer may be trained to move the block to a certain position reachable by the robotic arm when the block is found at a certain initial position.

In some aspects, the geometric algebra transformer can include an input equilinear layer (e.g., the input equilinear layer 302 of FIG. 3), a transformer block (e.g., the transformer block 304 of FIG. 3), and an output equilinear layer (e.g., the output equilinear layer 330 of FIG. 3). In some examples, the geometric algebra transformer can include a plurality of N transformer blocks (e.g., the N transformer blocks 304 of FIG. 3). In some cases, transformer block further includes one or more of a first normalization layer (e.g., the first normalization layer 306 of FIG. 3), a first equilinear layer (e.g., the first equilinear layer 308 of FIG. 3), a geometric attention layer (e.g., the geometric attention layer 310 of FIG. 3), a first geometric product engine (e.g., the first geometric product engine 313 of FIG. 3), a second equilinear layer (e.g., the second equilinear layer 312 of FIG. 3), a first addition engine (e.g., the first addition engine 316 of FIG. 3), a second normalization layer (e.g., the second normalization layer 318 of FIG. 3), a third equilinear layer (e.g., the third equilinear layer 320 of FIG. 3), a second geometric product engine (e.g., the second geometric product engine 322 of FIG. 3), a scalar-gated nonlinearity layer (e.g., the scalar-gated nonlinearity layer 324 of FIG. 3), a fourth equilinear layer (e.g., the fourth equilinear layer 326 of FIG. 3), a second addition engine (e.g., the second addition engine 328 of FIG. 3), or any combination thereof. In one illustrative example, the scalar-gated nonlinearity layer (e.g., the scalar-gated nonlinearity layer 324 of FIG. 3) can include a scalar-gated Gaussian Error Linear Units (GELU) nonlinearity layer.

Referring to FIG. 3 as one illustrative example of the flow of data through a geometric algebra transformer, the input equilinear layer 302 of the GATr network 312 can receive the multivector inputs 210 and generate an input equilinear layer output. The first normalization layer 306 can receive the input equilinear layer output and generate a first normalization layer output. The first equilinear layer 308 can receive the first normalization layer output and generate a first equilinear layer output. The geometric attention layer 310 can receive the first equilinear layer output and generate a geometric attention layer output. The first geometric product engine 313 can receive the geometric attention layer output and the first equilinear layer output and generate a first geometric product engine 313 output. The second equilinear layer 314 can receive the first geometric product engine 313 output and generate a second equilinear layer output. The first addition engine 316 can add the second equilinear layer output to the input equilinear layer output to generate a first addition output.

The second normalization layer 318 can receive the first addition output and generate a second normalization layer output. The third equilinear layer 320 can receive the second normalization layer output and generate a third equilinear layer output. The second geometric product engine 322 can receive the third equilinear layer output and generate a second geometric product engine output. The scalar-gated nonlinearity layer 324 can receive the second geometric product engine output and generate a scalar-gated nonlinearity layer output. The fourth equilinear layer 326 can receive the scalar-gated nonlinearity layer output and generate a fourth equilinear layer output. The second addition engine 328 can add the fourth equilinear layer output to the first addition output to generate a second addition output. The second addition output can be provided to the output equilinear layer 330, which can generate the multivector outputs 214 or an output equilinear layer output. In one illustrative example. the output equilinear layer output can include the multivector outputs from which data is extracted to control a motion of a device (e.g., to provide the final output 218 of FIG. 2 to control a device, such as a robot) or to perform one or more other tasks in the various contexts described herein (e.g., the geometric algebra transformer may generate a planet trajectory prediction, a robotic planning output, a molecular modeling output, etc.).

In some aspects, the first normalization layer, the first geometric product engine, the first addition engine, the second normalization layer, the second geometric product engine, the scalar-gated nonlinearity layer, and the second addition engine are fixed components. In some aspects, the first equilinear layer, the geometric attention layer, the second equilinear layer, the third equilinear layer, and the fourth equilinear layer are learnable components. In some examples, each layer maps between multivector data and is equivariant.

In some aspects, each layer maps between multivector data and is equivariant. In another aspect, the geometric algebra transformer represents both geometric objects and transformations of the geometric objects via the use of the multivector inputs (e.g., the multivector inputs 210 of FIG. 2). The multivector inputs can uniquely represent various geometric types.

In some cases, the geometric algebra transformer (e.g., via the GATr network 212 of FIG. 2, the GATr network 312 of FIG. 3, the computing system 900, or any one or more subcomponent thereof) represents both geometric objects and transformations of the geometric objects via use of the multivector inputs. For example, the multivector inputs may uniquely represent various geometric types. In some aspects, the multivector inputs are generated from a geometric product of vectors. In some cases, the multivector inputs include a representation of geometric objects and operators (e.g., a rotation and/or a reflection) associated with the geometric objects.

In one aspect, an apparatus for providing a geometric algebra transformer (e.g., the GATr network 212 of FIG. 2, the GATr network 312 of FIG. 3, the computing system 900, or any one or more subcomponent thereof) can include at least one memory and at least one processor coupled to at least one memory and configured to operate as a geometric algebra transformer. The at least one process can be configured to: receive multivector inputs processed from raw data associated with a three-dimensional space; and process the multivector inputs to generate multivector outputs, wherein the geometric algebra transformer is trained (1) to process geometric algebra representations associated with the multivector inputs and (2) to be equivariant with respect to translations and rotations.

An apparatus for using a geometric algebra transformer (e.g., via the GATr network 212 of FIG. 2. the GATr network 312 of FIG. 3, the computing system 900 of FIG. 9, or any one or more subcomponent thereof) can include at least one memory (e.g., a memory configured in circuitry such as one or more of memory 915, 920, 925 and/or 911 of FIG. 9) and at least one processor (e.g., processor 910 of FIG. 9) coupled to the at least one memory and configured to: receive multivector inputs 210 processed from raw data associated with a three-dimensional space and process the multivector inputs to generate multivector outputs 214, wherein the GATr network 212 is trained (1) to process geometric algebra representations associated with the multivector inputs 210 and (2) to be equivariant with respect to translations and rotations.

FIG. 8B illustrates another method or process 850 for using a geometric algebra transformer including the GATr network described herein. At block 852, the geometric algebra transformer can receive multivector inputs processed from raw data associated with a three-dimensional space. At block 854, the geometric algebra transformer can process the multivector inputs via at least one normalization layer 306, a geometric attention layer 310 that applies a dot product that subsumes a geometric algebra inner product, at least one equilinear layer 302, 308, 314, 320, 326, 330, and a scalar-gated nonlinearity layer 324, to generate multivector outputs, wherein the GATr network 212 can be trained (1) to process geometric algebra representations associated with the multivector inputs and (2) to be equivariant with respect to translations and rotations.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, a depth map or multiple depth maps, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache 911 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more GNSS receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B. C and C. A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to.” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z: or that multiple processors are each tasked with a certain subset of operations X. Y, and Z such that together the multiple processors perform X. Y. and Z; or that a group of multiple processors work together to perform operations X. Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A processor-implemented method of processing data using a geometric algebra transformer, the processor-implemented method comprising: receiving, at the geometric algebra transformer, multivector inputs processed from raw data associated with a three-dimensional space; and processing, via the geometric algebra transformer, the multivector inputs to generate multivector outputs, wherein the geometric algebra transformer is trained to process geometric algebra representations associated with the multivector inputs and to be equivariant with respect to translations and rotations.

Aspect 2. The processor-implemented method of Aspect 1, wherein the multivector inputs comprise multi-component multivectors.

Aspect 3. The processor-implemented method of any one of Aspects 1 or 2, wherein the multi-component multivectors comprise embedded geometric objects.

Aspect 4. The processor-implemented method of any one of Aspects 1 to 3, wherein the embedded geometric objects are embedded into the multi-component multivectors using a geometric algebra embedding component.

Aspect 5. The processor-implemented method of any one of Aspects 1 to 4, wherein the embedded geometric objects comprise at least one of a scalar, a vector, a bivector, a trivector, or a pseudoscalar.

Aspect 6. The processor-implemented method of any one of Aspects 1 to 5, wherein the geometric algebra transformer further comprises: an input equilinear layer; a transformer block; and an output equilinear layer.

Aspect 7. The processor-implemented method of any one of Aspects 1 to 6, wherein the geometric algebra transformer further comprises a plurality of transformer blocks.

Aspect 8. The processor-implemented method of any one of Aspects 1 to 7, wherein the transformer block further comprises: a first normalization layer; a first equilinear layer; a geometric attention layer; a first geometric product engine; a second equilinear layer; a first addition engine; a second normalization layer; a third equilinear layer; a second geometric product engine; a scalar-gated nonlinearity layer; a fourth equilinear layer; and a second addition engine.

Aspect 9. The processor-implemented method of any one of Aspects 1 to 8, wherein the scalar-gated nonlinearity layer comprises a scalar-gated Gaussian Error Linear Units nonlinearity layer.

Aspect 10. The processor-implemented method of any one of Aspects 1 to 9, wherein: the input equilinear layer is configured to receive the multivector inputs and generate an input equilinear layer output; the first normalization layer is configured to receive the input equilinear layer output and generate a first normalization layer output; the first equilinear layer is configured to receive the first normalization layer output and generate a first equilinear layer output; the geometric attention layer is configured to receive the first equilinear layer output and generate a geometric attention layer output; the first geometric product engine is configured to receive the geometric attention layer output and the first equilinear layer output and generate a first geometric product engine output; the second equilinear layer is configured to receive the first geometric product engine output and generate a second equilinear layer output; the first addition engine is configured to add the second equilinear layer output to the input equilinear layer output to generate a first addition output; the second normalization layer is configured to receive the first addition output and generate a second normalization layer output; the third equilinear layer is configured to receive the second normalization layer output and generate a third equilinear layer output; the second geometric product engine is configured to receive the third equilinear layer output and generate a second geometric product engine output; the scalar-gated nonlinearity layer is configured to receive the second geometric product engine output and generate a scalar-gated nonlinearity layer output; the fourth equilinear layer is configured to receive the scalar-gated nonlinearity layer output and generate a fourth equilinear layer output; and the second addition engine is configured to add the fourth equilinear layer output to the first addition output to generate a second addition output.

Aspect 11. The processor-implemented method of any one of Aspects 1 to 10, wherein the output equilinear layer is configured to receive the second addition output and generate an output equilinear layer output.

Aspect 12. The processor-implemented method of any one of Aspects 1 to 11, wherein the output equilinear layer output comprises the multivector outputs from which data is extracted to control a motion of a robot.

Aspect 13. The processor-implemented method of any one of Aspects 1 to 12, wherein the first normalization layer, the first geometric product engine, the first addition engine, the second normalization layer, the second geometric product engine, the scalar-gated nonlinearity layer, and the second addition engine are fixed components.

Aspect 14. The processor-implemented method of any one of Aspects 1 to 13, wherein the first equilinear layer, the geometric attention layer, the second equilinear layer, the third equilinear layer, and the fourth equilinear layer are learnable components.

Aspect 15. The processor-implemented method of any one of Aspects 1 to 14, wherein the multivector inputs comprise at least one of a scalar value, a plane with a normal value, a line with a direction value, a point value, a pseudoscalar value, a reflection value through a plane with a normal value, a translation value, a rotation value, or a point reflection value.

Aspect 16. The processor-implemented method of any one of Aspects 1 to 15, wherein each layer maps between multivector data and is equivariant.

Aspect 17. The processor-implemented method of any one of Aspects 1 to 16, wherein the geometric algebra transformer represents both geometric objects and transformations of the geometric objects via use of the multivector inputs.

Aspect 18. The processor-implemented method of any one of Aspects 1 to 17, wherein the multivector inputs uniquely represent various geometric types.

Aspect 19. The processor-implemented method of any one of Aspects 1 to 18, wherein the multivector inputs are generated from a geometric product of vectors.

Aspect 20. The processor-implemented method of any one of Aspects 1 to 19, wherein the multivector inputs comprises a representation of geometric objects and operators associated with the geometric objects.

Aspect 21. The processor-implemented method of any one of Aspects 1 to 20, wherein the operators comprise at least one of a rotation or a reflection.

Aspect 22. The processor-implemented method of any one of Aspects 1 to 21, wherein the geometric algebra transformer generates at least one of a planet trajectory prediction, a robotic planning output, or a molecular modeling output.

Aspect 23. A processor-implemented method of operating a geometric algebra transformer, the processor-implemented method comprising: receiving, at a geometric algebra transformer, multivector inputs processed from raw data associated with a three-dimensional space; and processing, via the geometric algebra transformer, the multivector inputs via at least a one normalization layer, a geometric attention layer configured to apply a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.

Aspect 24. An apparatus for processing data using a geometric algebra transformer, the apparatus comprising: at least one memory; and at least one processor coupled to at least one memory and configured to: receive, at the geometric algebra transformer, multivector inputs processed from raw data associated with a three-dimensional space; and process, via the geometric algebra transformer, the multivector inputs to generate multivector outputs, wherein the geometric algebra transformer is trained to process geometric algebra representations associated with the multivector inputs and to be equivariant with respect to translations and rotations.

Aspect 25. The apparatus of Aspect 24, wherein the multivector inputs comprise multi-component multivectors.

Aspect 26. The apparatus of any one of Aspects 24 to 25, wherein the multi-component multivectors comprise embedded geometric objects.

Aspect 27. The apparatus of any one of Aspects 24 to 26, wherein the embedded geometric objects are embedded into the multi-component multivectors using a geometric algebra embedding component.

Aspect 28. The apparatus of any one of Aspects 24 to 27, wherein the embedded geometric objects comprise at least one of a scalar, a vector, a bivector, a trivector, or a pseudoscalar.

Aspect 29. The apparatus of any one of Aspects 24 to 28, wherein the geometric algebra transformer further comprises: an input equilinear layer; a transformer block; and an output equilinear layer.

Aspect 30. The apparatus of any one of Aspects 24 to 29, wherein the geometric algebra transformer further comprises a plurality of transformer blocks.

Aspect 31. The apparatus of any one of any one of Aspects 24 to 30, wherein the transformer block further comprises: a first normalization layer; a first equilinear layer; a geometric attention layer; a first geometric product engine; a second equilinear layer; a first addition engine; a second normalization layer; a third equilinear layer; a second geometric product engine; a scalar-gated nonlinearity layer; a fourth equilinear layer; and a second addition engine.

Aspect 32. The apparatus of any one of Aspects 24 to 31, wherein the scalar-gated nonlinearity layer comprises a scalar-gated Gaussian Error Linear Units nonlinearity layer.

Aspect 33. The apparatus of any one of Aspects 24 to 32, wherein: the input equilinear layer is configured to receive the multivector inputs and generate an input equilinear layer output; the first normalization layer is configured to receive the input equilinear layer output and generate a first normalization layer output; the first equilinear layer is configured to receive the first normalization layer output and generate a first equilinear layer output; the geometric attention layer is configured to receive the first equilinear layer output and generate a geometric attention layer output; the first geometric product engine is configured to receive the geometric attention layer output and the first equilinear layer output and generate a first geometric product engine output; the second equilinear layer is configured to receive the first geometric product engine output and generate a second equilinear layer output; the first addition engine is configured to add the second equilinear layer output to the input equilinear layer output to generate a first addition output; the second normalization layer is configured to receive the first addition output and generate a second normalization layer output; the third equilinear layer is configured to receive the second normalization layer output and generate a third equilinear layer output; the second geometric product engine is configured to receive the third equilinear layer output and generate a second geometric product engine output; the scalar-gated nonlinearity layer is configured to receive the second geometric product engine output and generate a scalar-gated nonlinearity layer output; the fourth equilinear layer is configured to receive the scalar-gated nonlinearity layer output and generate a fourth equilinear layer output; and the second addition engine is configured to add the fourth equilinear layer output to the first addition output to generate a second addition output.

Aspect 34. The apparatus of any one of Aspects 24 to 33, wherein the output equilinear layer is configured to receive the second addition output and generate an output equilinear layer output.

Aspect 35. The apparatus of any one of Aspects 24 to 34, wherein the output equilinear layer output comprises the multivector outputs from which data is extracted to control a motion of a robot.

Aspect 36. The apparatus of any one of Aspects 24 to 36, wherein the first normalization layer, the first geometric product engine, the first addition engine, the second normalization layer, the second geometric product engine, the scalar-gated nonlinearity layer, and the second addition engine are fixed components.

Aspect 37. The apparatus of any one of Aspects 24 to 36, wherein the first equilinear layer, the geometric attention layer, the second equilinear layer, the third equilinear layer, and the fourth equilinear layer are learnable components.

Aspect 38. The apparatus of any one of Aspects 24 to 37, wherein the multivector inputs comprise at least one of a scalar value, a plane with a normal value, a line with a direction value, a point value, a pseudoscalar value, a reflection value through a plane with a normal value, a translation value, a rotation value, or a point reflection value.

Aspect 39. The apparatus of any one of any one of Aspects 24 to 38, wherein each layer maps between multivector data and is equivariant.

Aspect 40. The apparatus of any one of Aspects 24 to 39, wherein the geometric algebra transformer represents both geometric objects and transformations of the geometric objects via use of the multivector inputs.

Aspect 41. The apparatus of any one of Aspects 24 to 40, wherein the multivector inputs uniquely represent various geometric types.

Aspect 42. The apparatus of any one of Aspects 24 to 41, wherein the multivector inputs are generated from a geometric product of vectors.

Aspect 43. The apparatus of any one of Aspects 24 to 42, wherein the multivector inputs comprises a representation of geometric objects and operators associated with the geometric objects.

Aspect 44. The apparatus of any one of Aspects 24 to 43, wherein the operators comprise at least one of a rotation or a reflection.

Aspect 45. The apparatus of any one of Aspects 24 to 44, wherein the geometric algebra transformer generates at least one of a planet trajectory prediction, a robotic planning output, or a molecular modeling output.

Aspect 46. An apparatus for operating a geometric algebra transformer, the apparatus comprising: at least one memory; and at least one processor coupled to at least one memory and configured to: receive, at a geometric algebra transformer, multivector inputs processed from raw data associated with a three-dimensional space; and process, via the geometric algebra transformer, the multivector inputs via at least a one normalization layer, a geometric attention layer configured to apply a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.

Aspect 47. A non-transitory computer-readable storage medium comprising instructions stored thereon which, when executed by at least one processor, causes the at least one processor to perform operations according to any one of Aspects 1 to 23.

Aspect 48. An apparatus for processing image data, comprising one or more means for performing operations according to any one of Aspects 1 to 23.

What is claimed is:

1. A processor-implemented method of processing data using a geometric algebra transformer, the processor-implemented method comprising:
receiving, at the geometric algebra transformer, multivector inputs processed from raw data associated with a three-dimensional space; and
processing, via the geometric algebra transformer, the multivector inputs to generate multivector outputs, wherein the geometric algebra transformer is trained to process geometric algebra representations associated with the multivector inputs and to be equivariant with respect to translations and rotations.

2. The processor-implemented method of claim 1, wherein the multivector inputs comprise multi-component multivectors.

3. The processor-implemented method of claim 2, wherein the multi-component multivectors comprise embedded geometric objects.

4. The processor-implemented method of claim 3, wherein the embedded geometric objects are embedded into the multi-component multivectors using a geometric algebra embedding component.

5. The processor-implemented method of claim 3, wherein the embedded geometric objects comprise at least one of a scalar, a vector, a bivector, a trivector, or a pseudoscalar.

6. The processor-implemented method of claim 1, wherein the geometric algebra transformer further comprises:
an input equilinear layer;
a transformer block; and
an output equilinear layer.

7. The processor-implemented method of claim 6, wherein the geometric algebra transformer further comprises a plurality of transformer blocks.

8. The processor-implemented method of claim 6, wherein the transformer block further comprises:
a first normalization layer;
a first equilinear layer;
a geometric attention layer;
a first geometric product engine;
a second equilinear layer;
a first addition engine;
a second normalization layer;
a third equilinear layer;
a second geometric product engine;
a scalar-gated nonlinearity layer;
a fourth equilinear layer; and
a second addition engine.

9. The processor-implemented method of claim 8, wherein the scalar-gated nonlinearity layer comprises a scalar-gated Gaussian Error Linear Units nonlinearity layer.

10. The processor-implemented method of claim 8, wherein:
the input equilinear layer is configured to receive the multivector inputs and generate an input equilinear layer output;
the first normalization layer is configured to receive the input equilinear layer output and generate a first normalization layer output;
the first equilinear layer is configured to receive the first normalization layer output and generate a first equilinear layer output;
the geometric attention layer is configured to receive the first equilinear layer output and generate a geometric attention layer output;
the first geometric product engine is configured to receive the geometric attention layer output and the first equilinear layer output and generate a first geometric product engine output;
the second equilinear layer is configured to receive the first geometric product engine output and generate a second equilinear layer output;
the first addition engine is configured to add the second equilinear layer output to the input equilinear layer output to generate a first addition output;
the second normalization layer is configured to receive the first addition output and generate a second normalization layer output;
the third equilinear layer is configured to receive the second normalization layer output and generate a third equilinear layer output;
the second geometric product engine is configured to receive the third equilinear layer output and generate a second geometric product engine output;
the scalar-gated nonlinearity layer is configured to receive the second geometric product engine output and generate a scalar-gated nonlinearity layer output;
the fourth equilinear layer is configured to receive the scalar-gated nonlinearity layer output and generate a fourth equilinear layer output; and
the second addition engine is configured to add the fourth equilinear layer output to the first addition output to generate a second addition output.

11. The processor-implemented method of claim 10, wherein the output equilinear layer is configured to receive the second addition output and generate an output equilinear layer output and wherein the output equilinear layer output comprises the multivector outputs from which data is extracted to control a motion of a robot.

12. The processor-implemented method of claim 8, wherein the first normalization layer, the first geometric product engine, the first addition engine, the second normalization layer, the second geometric product engine, the scalar-gated nonlinearity layer, and the second addition engine are fixed components and wherein the first equilinear layer, the geometric attention layer, the second equilinear layer, the third equilinear layer, and the fourth equilinear layer are learnable components.

13. The processor-implemented method of claim 8, wherein each layer maps between multivector data and is equivariant.

14. The processor-implemented method of claim 1, wherein the multivector inputs comprise at least one of a scalar value, a plane with a normal value, a line with a direction value, a point value, a pseudoscalar value, a reflection value through a plane with a normal value, a translation value, a rotation value, or a point reflection value and wherein the geometric algebra transformer represents both geometric objects and transformations of the geometric objects via use of the multivector inputs.

15. The processor-implemented method of claim 1, wherein the multivector inputs uniquely represent various geometric types.

16. The processor-implemented method of claim 1, wherein the multivector inputs are generated from a geometric product of vectors and wherein the multivector inputs comprises a representation of geometric objects and operators associated with the geometric objects.

17. The processor-implemented method of claim 16, wherein the operators comprise at least one of a rotation or a reflection.

18. The processor-implemented method of claim 1, wherein the geometric algebra transformer generates at least one of a planet trajectory prediction, a robotic planning output, or a molecular modeling output.

19. A processor-implemented method of operating a geometric algebra transformer, the processor-implemented method comprising:
receiving, at a geometric algebra transformer, multivector inputs processed from raw data associated with a three-dimensional space; and
processing, via the geometric algebra transformer, the multivector inputs via at least a one normalization layer, a geometric attention layer configured to apply a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.

20. An apparatus for processing data using a geometric algebra transformer, the apparatus comprising:
at least one memory; and
at least one processor coupled to at least one memory and configured to:
receive, at the geometric algebra transformer, multivector inputs processed from raw data associated with a three-dimensional space; and
process, via the geometric algebra transformer, the multivector inputs to generate multivector outputs, wherein the geometric algebra transformer is trained to process geometric algebra representations associated with the multivector inputs and to be equivariant with respect to translations and rotations.

21. The apparatus of claim 20, wherein the multivector inputs comprise multi-component multivectors and wherein the multi-component multivectors comprise embedded geometric objects.

22. The apparatus of claim 21, wherein the embedded geometric objects are embedded into the multi-component multivectors using a geometric algebra embedding component and wherein the embedded geometric objects comprise at least one of a scalar, a vector, a bivector, a trivector, or a pseudoscalar.

23. The apparatus of claim 20, wherein the geometric algebra transformer further comprises:
an input equilinear layer;
a transformer block; and
an output equilinear layer.

24. The apparatus of claim 23, wherein the geometric algebra transformer further comprises a plurality of transformer blocks.

25. The apparatus of claim 23, wherein the transformer block further comprises:
a first normalization layer;
a first equilinear layer;
a geometric attention layer;
a first geometric product engine;
a second equilinear layer;
a first addition engine;
a second normalization layer;
a third equilinear layer;
a second geometric product engine;
a scalar-gated nonlinearity layer;
a fourth equilinear layer; and
a second addition engine.

26. The apparatus of claim 25, wherein the scalar-gated nonlinearity layer comprises a scalar-gated Gaussian Error Linear Units nonlinearity layer.

27. The apparatus of claim 25, wherein:
the input equilinear layer is configured to receive the multivector inputs and generate an input equilinear layer output;
the first normalization layer is configured to receive the input equilinear layer output and generate a first normalization layer output;
the first equilinear layer is configured to receive the first normalization layer output and generate a first equilinear layer output;
the geometric attention layer is configured to receive the first equilinear layer output and generate a geometric attention layer output;
the first geometric product engine is configured to receive the geometric attention layer output and the first equilinear layer output and generate a first geometric product engine output;
the second equilinear layer is configured to receive the first geometric product engine output and generate a second equilinear layer output;
the first addition engine is configured to add the second equilinear layer output to the input equilinear layer output to generate a first addition output;
the second normalization layer is configured to receive the first addition output and generate a second normalization layer output;
the third equilinear layer is configured to receive the second normalization layer output and generate a third equilinear layer output;
the second geometric product engine is configured to receive the third equilinear layer output and generate a second geometric product engine output;
the scalar-gated nonlinearity layer is configured to receive the second geometric product engine output and generate a scalar-gated nonlinearity layer output;
the fourth equilinear layer is configured to receive the scalar-gated nonlinearity layer output and generate a fourth equilinear layer output; and
the second addition engine is configured to add the fourth equilinear layer output to the first addition output to generate a second addition output.

28. The apparatus of claim 27, wherein the output equilinear layer is configured to receive the second addition output and generate an output equilinear layer output and wherein the output equilinear layer output comprises the multivector outputs from which data is extracted to control a motion of a robot.

29. The apparatus of claim 25, wherein the first normalization layer, the first geometric product engine, the first addition engine, the second normalization layer, the second geometric product engine, the scalar-gated nonlinearity layer, and the second addition engine are fixed components and wherein the first equilinear layer, the geometric attention layer, the second equilinear layer, the third equilinear layer, and the fourth equilinear layer are learnable components.

30. An apparatus for operating a geometric algebra transformer, the apparatus comprising:
at least one memory; and
at least one processor coupled to at least one memory and configured to:
receive, at a geometric algebra transformer, multivector inputs processed from raw data associated with a three-dimensional space; and
process, via the geometric algebra transformer, the multivector inputs via at least a one normalization layer, a geometric attention layer configured to apply a dot product that subsumes a geometric algebra inner product, at least one equilinear layer, and a scalar-gated nonlinearity layer, to generate multivector outputs, wherein the geometric algebra transformer is trained to process geometric algebra representations associated with the multivector inputs and to be equivariant with respect to translations and rotations.
